(19) United States
(12) Patent Application Publication
(10) Pub. No.: US 2010/0153288 A1
(43) Pub. Date: Jun. 17, 2010

(54) COLLABORATIVE CAREER DEVELOPMENT

(76) Inventors: Ernesto Digiambattista, Revere, MA (US); Adriana Petrillo, Lynnfield, MA (US)

Correspondence Address: HOLLAND & KNIGHT LLP, 10 ST. JAMES AVENUE, BOSTON, MA, 02116-3889, US

(21) Appl. No.: 12/638,714

(22) Filed: Dec. 15, 2009

Related U.S. Application Data
(60) Provisional application No. 61/122,559, filed on Dec. 15, 2008.

(51) Int. Cl. G06Q 10/00; G06F 15/16; G06F 3/048

(52) U.S. Cl. 705/319; 705/321; 709/203; 715/764

(57) ABSTRACT

A method and computer program product for candidate-position matching may comprise defining for a candidate, via at least one of a client electronic device and a server computer, a candidate skill level for a predefined skill A skill match metric for the candidate may be determined, based upon, at least in part, the candidate skill level and a desired candidate skill level. The skill match metric for the candidate may be outputted.

### RELATED APPLICATIONS

This application claims priority to provisional application Ser. No. 61/122,559 filed on Dec. 15, 2008, which is herein incorporated by reference in its entirety.

### BACKGROUND OF THE INVENTION

This disclosure relates to collaborative career development and, more particularly, to methodologies for candidate-position matching (CPM).

Employers may invest a great deal of time and money into recruiting. They may spend this time and money reviewing application materials such as resumes and cover letters and may not have all the relevant information about candidates that they need. For at least these reasons, employers may not be as efficient or accurate in matching candidates to open positions as they could be.

Further, candidates may become frustrated while searching for positions. While they may submit resumes and cover letters to employers, they may still be unable to convey relevant information to employers regarding their skill sets, behavioral background, and other candidate information. For at least these reasons, candidates may miss employment opportunities or may not be considered for positions that they may be qualified for.

Accordingly, employers may need an application that allows them to collect and view relevant information about candidates regarding their skill sets, behavioral background, and other candidate information. Additionally, candidates may need an application to assist them in acquiring a position by matching their skill sets, behavioral background, and other candidate information with employers and open positions. Also, employers may need to reduce the cost and time for acquiring human resources.

### BRIEF SUMMARY OF THE INVENTION

In a first implementation, a method may comprise defining for a candidate, via at least one of a client electronic device and a server computer, a candidate skill level for a predefined skill The method may further comprise determining, via at least one of the client electronic device and the server computer, a skill match metric for the candidate, based upon, at least in part, the candidate skill level and a desired candidate skill level. The method may also comprise outputting the skill match metric for the candidate.

One or more of the following features may be included. The method may include determining a candidate match metric for a position based upon, at least in part, a plurality of skill match metrics for a plurality of desired skills and displaying at least one of the skill match metric and the candidate match metric in a graphical user interface. The method may further include displaying a plurality of candidate match metrics for the position. Additionally, the method may include displaying a plurality of skill match metrics for at least two candidates for the position.

In some embodiments, determining the candidate match metric may further comprise defining for the candidate, via at least one of the client electronic device and the server computer, a behavioral characteristic level for a predefined behavioral characteristic. It may further comprise determining, via at least one of the client electronic device and the server computer, a behavioral characteristic match metric for the candidate based upon, at least in part, the behavioral characteristic level and a desired behavioral characteristic level. Moreover it may comprise displaying the behavioral characteristic match metric for the candidate.

In another embodiment, the method may additionally comprise determining the candidate match metric for the position based upon, at least in part, a plurality of behavioral characteristic match metrics for a plurality of desired behavioral characteristics and displaying the candidate match metric. The method may further comprise displaying a plurality of behavioral characteristic match metrics for at least two candidates for the position. Determining the candidate match metric may be further based upon, at least in part, at least one of a professional history and an educational history. At least one of the skill match metric, the candidate match metric, and the behavioral characteristic match metric may be a percentage.

In one embodiment, the method may further comprise creating a template for the position including a plurality of predefined skills, each predefined skill having a definable candidate skill level and defining in the template the desired candidate skill level for each predefined skill The method may also comprise including in the template a plurality of predefined behavioral characteristics, each behavioral characteristic having a definable behavioral characteristic level and defining in the template the desired behavioral characteristic level for each predefined behavioral characteristic.

In a second implementation, a computer program product may reside on a computer readable storage medium and have a plurality of instructions stored on it. When executed by a processor, the instructions may cause the processor to perform operations comprising defining for a candidate, via at least one of a client electronic device and a server computer, a candidate skill level for a predefined skill. The operations may further comprise determining, via at least one of the client electronic device and the server computer, a skill match metric for the candidate, based upon, at least in part, the candidate skill level and a desired candidate skill level, and outputting the skill match metric for the candidate.

One or more of the following features may be included. The operations may include determining a candidate match metric for a position based upon, at least in part, a plurality of skill match metrics for a plurality of desired skills and displaying at least one of the skill match metric and the candidate match metric in a graphical user interface. The operations may further include displaying a plurality of candidate match metrics for the position. Additionally, the operations may include displaying a plurality of skill match metrics for at least two candidates for the position.

In some embodiments, determining the candidate match metric may further comprise defining for the candidate, via at least one of the client electronic device and the server computer, a behavioral characteristic level for a predefined behavioral characteristic. It may further comprise determining, via at least one of the client electronic device and the server computer, a behavioral characteristic match metric for the candidate based upon, at least in part, the behavioral characteristic level and a desired behavioral characteristic level. Moreover it may comprise displaying the behavioral characteristic match metric for the candidate.

In another embodiment, the operations may additionally comprise determining the candidate match metric for the position based upon, at least in part, a plurality of behavioral characteristic match metrics for a plurality of desired behavioral characteristics and displaying the candidate match metric. The operations may further comprise displaying a plurality of behavioral characteristic match metrics for at least two candidates for the position. Determining the candidate match metric may be further based upon, at least in part, at least one of a professional history and an educational history. At least one of the skill match metric, the candidate match metric, and the behavioral characteristic match metric may be a percentage.

In one embodiment, the operations may further comprise creating a template for the position including a plurality of predefined skills, each predefined skill having a definable candidate skill level and defining in the template the desired candidate skill level for each predefined skill The operation may also comprise including in the template a plurality of predefined behavioral characteristics, each behavioral characteristic having a definable behavioral characteristic level and defining in the template the desired behavioral characteristic level for each predefined behavioral characteristic.

In a third implementation a method may comprise obtaining, via at least one of a client electronic device and a server computer, at least one of candidate information or position information from a social network. The method may further comprise determining, via at least one of the client electronic device and the server computer, a skill match metric for a candidate, a behavioral characteristic match metric for the candidate, and a candidate match metric for a position based upon, at least in part, at least one of the skill match metric, the behavioral characteristic match metric, the candidate information, and the position information. The method may also comprise outputting the candidate match metric in a graphical user interface.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a candidate-position matching (CPM) process coupled to a distributed computing network;

FIG. 2 is a flowchart of the CPM process of FIG. 1;

FIG. 3 is continuation of the flowchart of the CPM process of FIG. 1;

FIG. 4 is a diagrammatic view of a GUI associated with a collaborative career development application (CCDA) and/or CPM process;

FIG. 5 is a diagrammatic view of a GUI associated with the CCDA and/or CPM process;

FIG. 6 is a diagrammatic view of a GUI associated with the CCDA and/or CPM process;

FIG. 7 is a diagrammatic view of a GUI associated with the CCDA and/or CPM process;

FIG. 8 is a diagrammatic view of a GUI associated with the CCDA and/or CPM process;

FIG. 9 is a diagrammatic view of a GUI associated with the CCDA and/or CPM process;

FIG. 10 is a diagrammatic view of a GUI associated with the CCDA and/or CPM process;

FIG. 11 is a diagrammatic view of a GUI associated with the CCDA and/or CPM process;

FIG. 12 is a diagrammatic view of a GUI associated with the CCDA and/or CPM process;

FIG. 13 is a diagrammatic view of a GUI associated with the CCDA and/or CPM process;

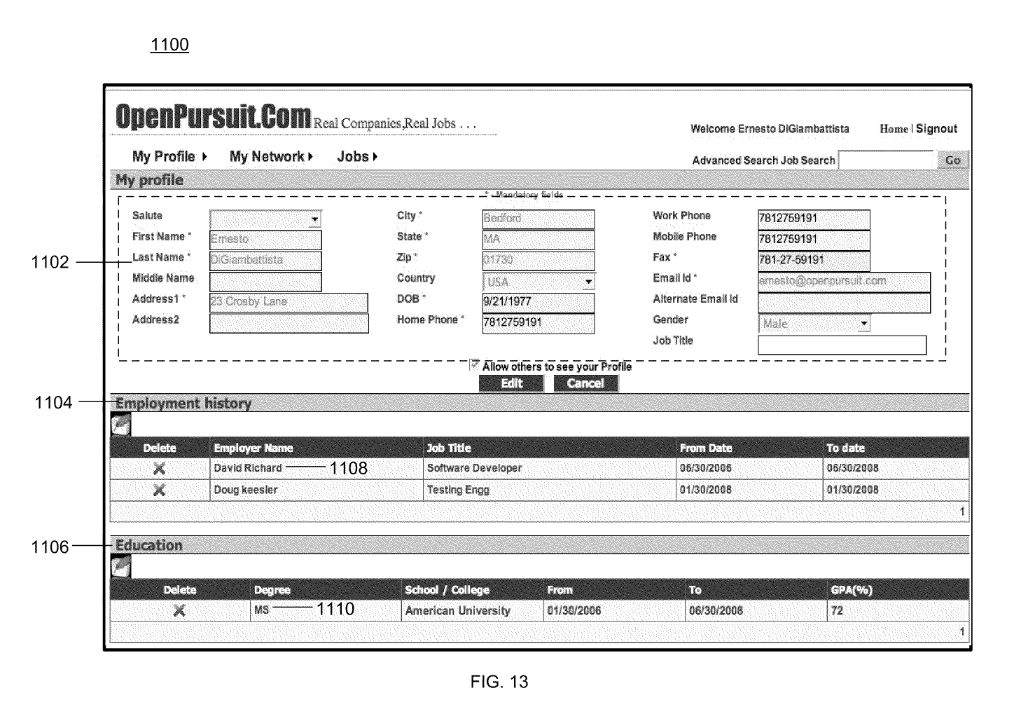

FIG. 14 is a diagrammatic view of a GUI associated with the CCDA and/or CPM process;

FIG. 15 is a diagrammatic view of a GUI associated with the CCDA and/or CPM process;

FIG. 16 is a diagrammatic view of a GUI associated with the CCDA and/or CPM process;

FIG. 17 is a diagrammatic view of a GUI associated with the CCDA and/or CPM process;

FIG. 18 is a diagrammatic view of a GUI associated with the CCDA and/or CPM process;

FIG. 19 is a diagrammatic view of a GUI associated with the CCDA and/or CPM process;

FIG. 20 is a diagrammatic view of a GUI associated with the CCDA and/or CPM process;

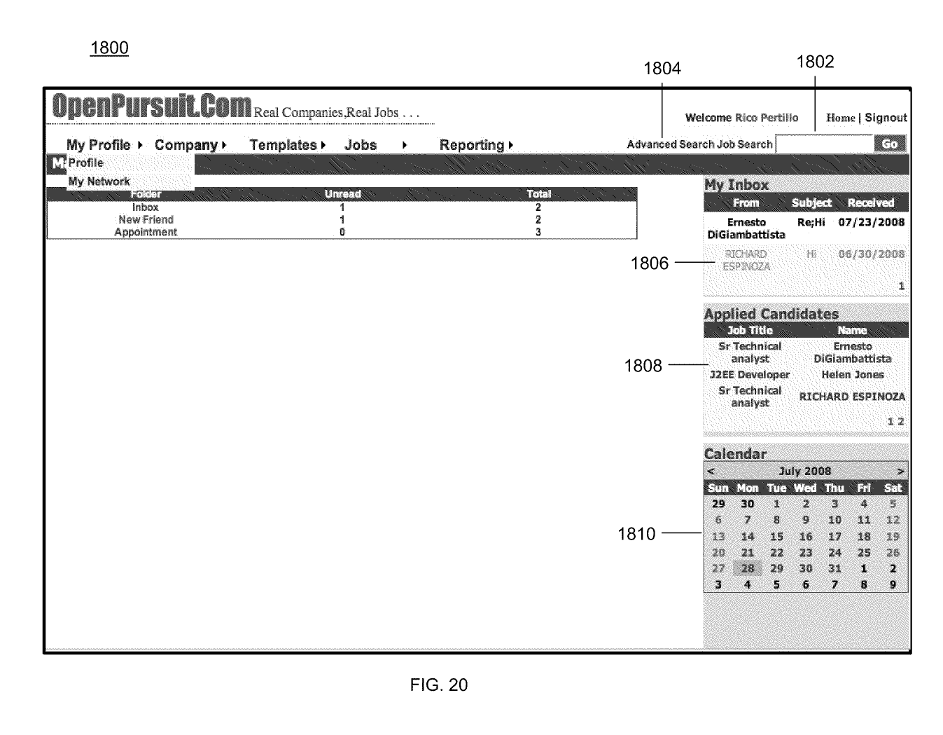

FIG. 21 is a diagrammatic view of a GUI associated with the CCDA and/or CPM process;

FIG. 22 is a diagrammatic view of a GUI associated with the CCDA and/or CPM process;

FIG. 23 is a diagrammatic view of a GUI associated with the CCDA and/or CPM process;

FIG. 24 is a diagrammatic view of a GUI associated with the CCDA and/or CPM process;

FIG. 25 is a diagrammatic view of a GUI associated with the CCDA and/or CPM process; and

FIG. 26 is a diagrammatic view of a GUI associated with the CCDA and/or CPM process.

### DETAILED DESCRIPTION OF THE INVENTION

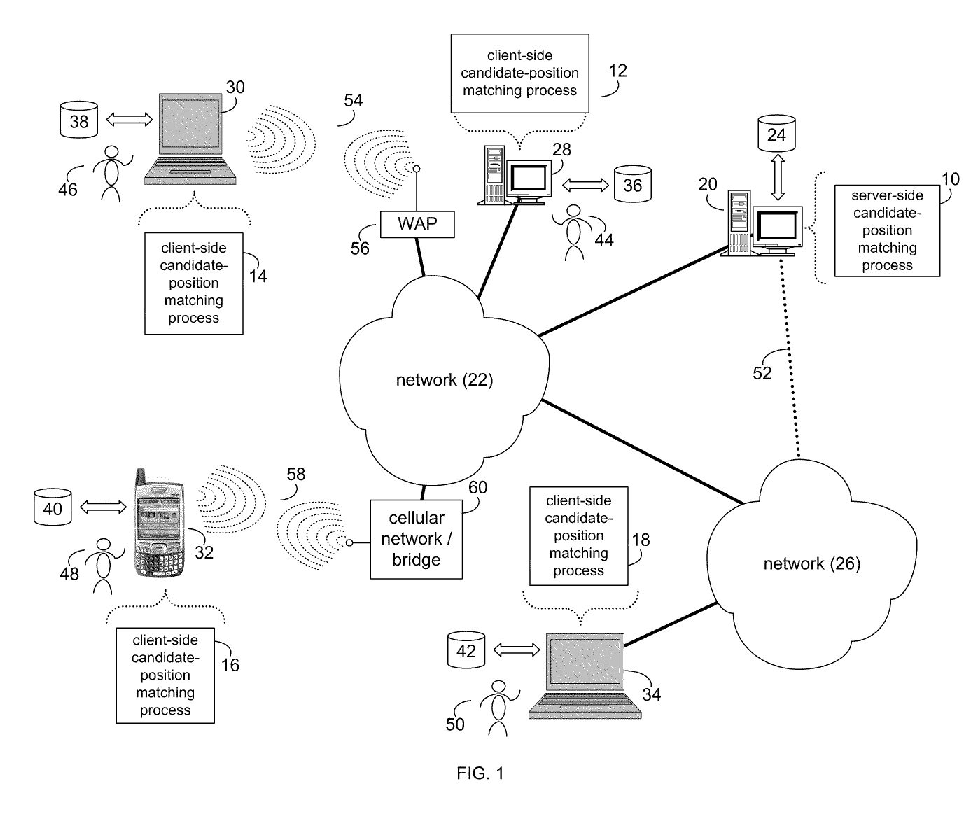

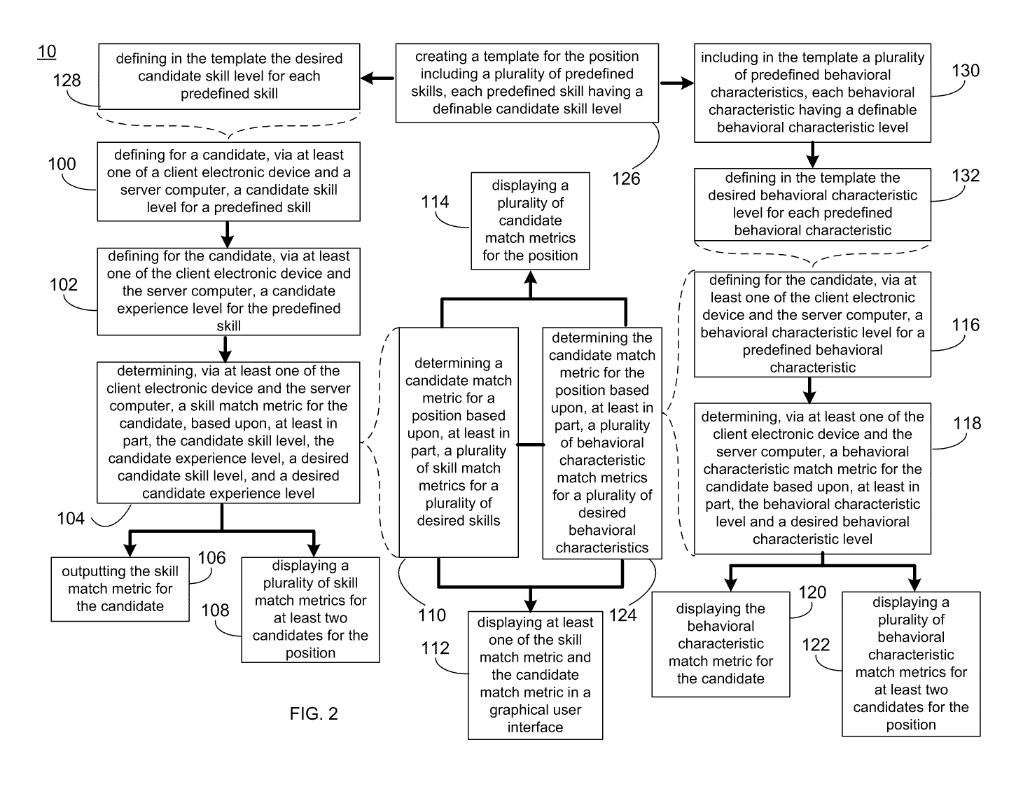

Referring to FIGS. 1, 2, & 3 there is shown a candidate-position matching (CPM) process 10. As will be discussed below, CPM process 10 may define 100 for a candidate, via at least one of a client electronic device and a server computer, a candidate skill level for a predefined skill A candidate experience level may be defined 102 for the candidate, via at least one of the client electronic device and the server computer.

The CPM process may be a server-side process (e.g., server-side CPM process 10), a client-side process (e.g., client-side CPM process 12, client-side CPM process 14, client-side CPM process 16, or client-side CPM process 18), or a hybrid server-side/client-side process (e.g., the combination of server-side CPM process 10 and one or more of client-side CPM process 12, 14, 16, 18).

Server-side CPM process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and a mainframe computer. Server computer 20 may be a web server (or a series of servers) running a network operating system, examples of which may include but are not limited to: Microsoft Windows XP Server™; Novell Netware™; or Redhat Linux™, for example.

The instruction sets and subroutines of server-side CPM process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft IIS™, Novell Webserver™, or Apache Webserver™, that allows for access to server computer 20 (via network 22) using one or more protocols, examples of which may include but are not limited to HTTP (i.e., HyperText Transfer Protocol), SIP (i.e., session initiation protocol), and the Lotus Sametime™ VP protocol. Network 22 may be connected to one or more secondary networks (e.g., network 26), examples of which may include but are not limited to: a local area network; a wide area network; or an intranet, for example.

Client-side CPM processes 12, 14, 16, 18 may reside on and may be executed by client electronic devices 28, 30, 32, 34 (respectively), examples of which may include but are not limited to personal computer 28, laptop computer 30, personal digital assistant 32, notebook computer 34, a data-enabled cellular telephone (not shown), smart phone (not shown), and a dedicated network device (not shown), for example. Client electronic devices 28, 30, 32, 34 may each be coupled to network 22 and/or network 26 and may each execute an operating system, examples of which may include but are not limited to Microsoft Windows™, Microsoft Windows CE™, Redhat Linux™, or a custom operating system.

The instruction sets and subroutines of client-side CPM processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

One or more of client-side CPM processes 12, 14, 16, 18 and server-side CPM process 10 may interface with each other (via network 22 and/or network 26) to allow a plurality of users (e.g., user 44, 46, 48, 50) to transmit candidate information and/or position information.

Users 44, 46, 48, 50 may access server-side CPM process 10 directly through the device on which the client-side CPM process (e.g., client-side CPM processes 12, 14, 16, 18) is executed, namely client electronic devices 28, 30, 32, 34, for example. Users 44, 46, 48, 50 may access server-side CPM process 10 directly through network 22 and/or through secondary network 26. Further, server computer 20 (i.e., the computer that executes server-side CPM process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, Wi-Fi, and/or Bluetooth device that is capable of establishing wireless communication channel 54 between laptop computer 30 and WAP 56. Personal digital assistant 32 is shown wirelessly coupled to network 22 via wireless communication channel 58 established between personal digital assistant 32 and cellular network/bridge 60, which is shown directly coupled to network 22.

The server-side CPM process 10 and/or client-side CPM process 12 may be part of a collaborative career development application (CCDA) which may run on a server computer (e.g. server computer 20), a client electronic device (e.g., client electronic devices 28, 30, 32, 34) or may be a hybrid server-side/client-side application. The CCDA may allow the user to upload or post various types of candidate application documents such as resumes, cover letters, letters of recommendation, transcripts, and the like. All of the operations and methods described herein may be carried out by either server-side CPM process 10, client-side CPM process 12, or one or more other processes which may be a part of the CCDA. Further, the CCDA, server-side CPM process 10, and/or client-side CPM process 12 may generate, create, and/or display a number of graphical user interfaces (GUI), as described below. It should be noted that while server server-side CPM process 10, and client-side CPM process 12 may be part of the CCDA, they may also be stand alone applications. As such, any one of the CCDA, server-side CPM process 10, and client-side CPM process 12 alone or in combination may generate, create, and/or display the GUI's described below. The CCDA will be described below in greater detail.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Candidate-Position Matching (CPM) Process

For the following discussion, server-side CPM process 10 will be described for illustrative purposes. Client-side CPM process 12 may be incorporated into server-side CPM process 10. However, this is not intended to be a limitation of this disclosure, as other configurations are possible (e.g., stand-alone, client-side CPM processes and/or stand-alone server-side CPM processes.) For example, some implementations may include one or more of client-side CPM processes 14, 16, 18 in place of or in addition to client-side CPM process 12.

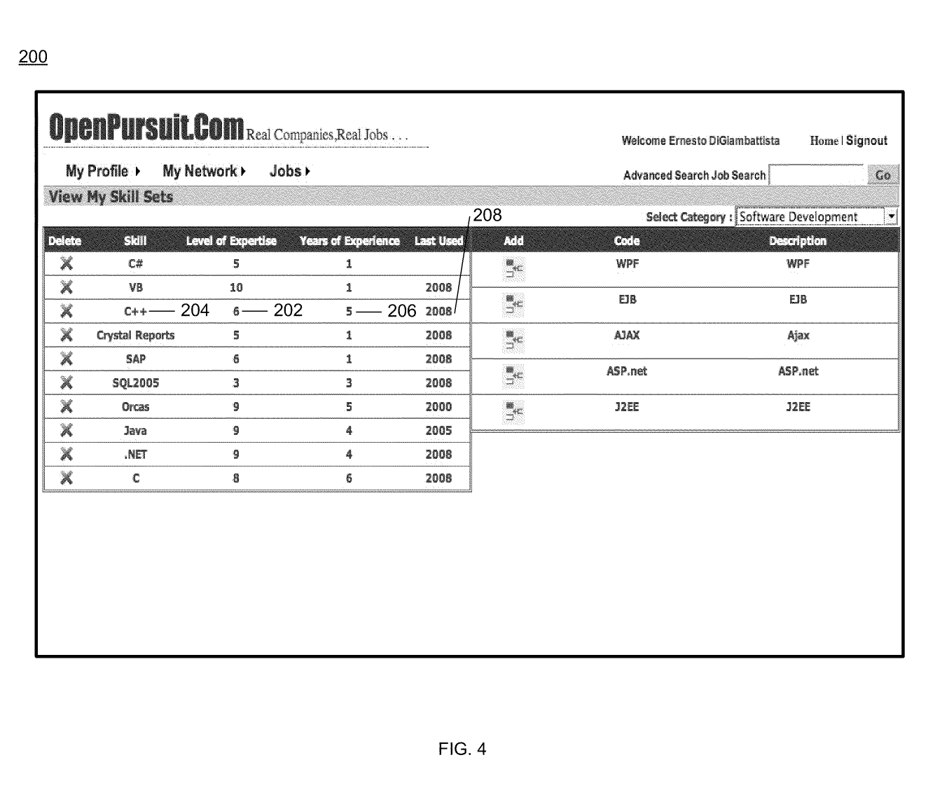

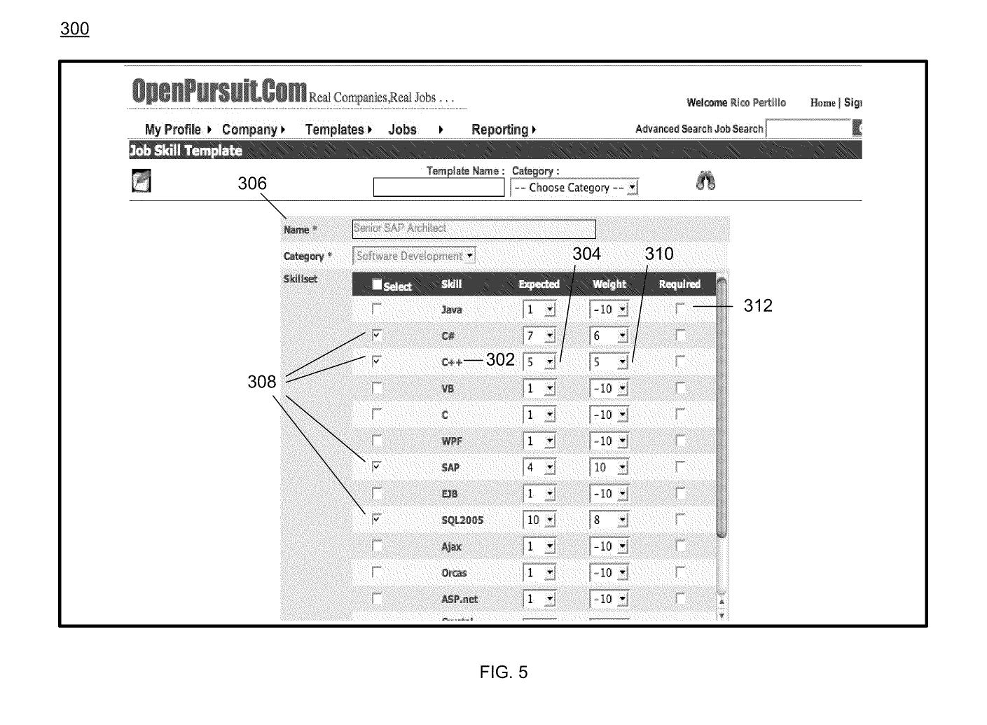

Referring now to FIGS. 1-5, server-side CPM process 10 may define 100 for a candidate, candidate skill level 202 for predefined skill 204. Predefined skill 204 may be defined by an employer seeking to fill a position. For example, predefined skill 204 may be entered and/or selected 302, as shown in graphical user interface GUI 300 in FIG. 5, by an employer (e.g., users 44, 46, 48, or 50) at a client electronic device, including but not limited to client electronic devices 28, 30, 32, 34. Predefined skill 204 may also be entered by an employer at a server computer (e.g., server computer 20). Server-side CPM process 10 may receive predefined skill 204 (e.g., from client-side CPM process 12) and may define predefined skill 204 such that it appears on GUI 200, as shown in FIG. 4.

In some implementations, the candidate may enter a skill which does not appear in GUI 300 using free text (e.g., typing in the skill), and then enter a candidate skill level for that skill Server-side CPM process 10 may add the free text skill entered by the candidate into a candidate information database that may be used by server-side CPM process 10. The free text skill may then be defined subsequently as a predefined skill by an employer seeking to fill a future position.

Candidate skill level 202 may be entered by a candidate (e.g., users 44, 46, 48, or 50) seeking a position. The candidate may enter candidate skill level 202 based upon the level of skill the candidate has regarding the predefined skill For example, if the predefined skill is “C++” (i.e. the C++ programming language), as designated by predefined skill 204 in GUI 200, the candidate may enter “6”, as designated by candidate skill level 202. GUI 200 may allow the candidate choose candidate skill level 202 on a 1-10 scale, however other configurations are possible. For example, the scale may be 1-100, A-F, or good-average-bad. Server-side CPM process 10 may receive candidate skill level 202 (e.g., from client-side CPM process 12).

While the skills (e.g., predefined skills) shown in GUI 200 and discussed throughout the present disclosure may be skills associated with computers or software development, various other skills for various other categories of positions may be included. For example, if the position were a driving position, skills such as truck driving, long distance driving, commercial vehicle driving, and other driving skills could be included. Further by way of example, if the position were a police officer position, skills such as shooting, driving, self defense, and investigation skills could be included. In another example, if the position were a nursing position, skills such as checking blood pressure, emergency room skills, and wound stitching skills may be included. Any number of skills may be included, and they may be broad or narrow, depending on the position and its requirements.

Server-side CPM process 10 may also define 102 for a candidate, candidate experience level 206 for predefined skill 204. Candidate experience level 206 may be entered by a candidate (e.g., users 44, 46, 48, or 50) seeking a position. The candidate may enter candidate skill level 206 based upon the experience the candidate has regarding the predefined skill For example, the candidate may enter “5”, if that is how many years of experience the candidate has with the predefined skill Candidate skill level 206 may be entered in years, for example, as shown in GUI 200. Candidate skill level 206 may also be entered in any other unit of time, such as months, weeks, hours, etc. Similarly, server-side CPM process 10 may define last used date 208 for predefined skill 204, which may also be entered by a candidate (e.g., users 44, 46, 48, or 50) seeking a position. The candidate may enter last used date 208 based upon the last date the candidate used predefined skill 204. For example, the candidate may enter “2005”, if that was the last time the candidate used the predefined skill While last used date 208 is shown as a year in GUI 200, it may also include a month, day, or specific time.

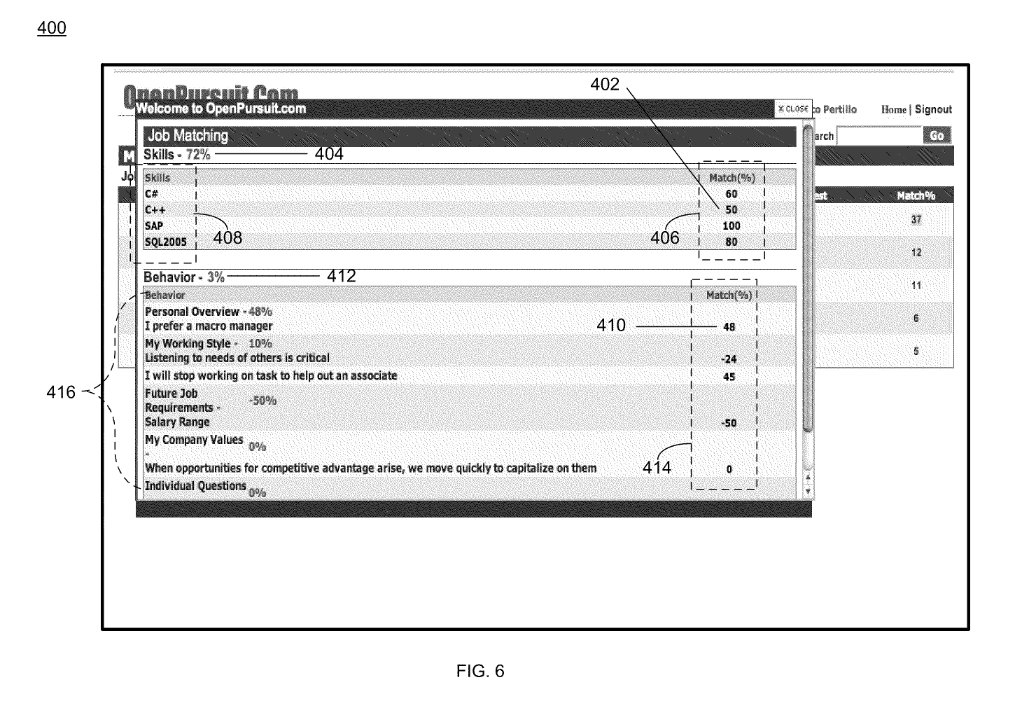

Referring now to FIGS. 1-6, server-side CPM process 10 may determine 104 skill match metric 402 for the candidate, based upon, at least in part, candidate skill level 202 and desired candidate skill level 304. Candidate experience level 206 and a desired candidate experience level may also be used to determine skill match metric 402. Server-side CPM process 10 may determine 104 skill match metric 402 using a variety of methods and formulas. It should be noted that the numbers shown in the figures are shown for exemplary purposes only, and may not be actual numbers calculated using the numbers shown. By way of example and not limitation, if the desired candidate skill level is 8 (e.g., desired candidate skill level 304 for predefined skill 204), and the candidate skill level is 4 (e.g., candidate skill level 202), the skill match metric may be 50% (e.g. skill match metric 402 as shown in GUI 400 in FIG. 6). In other words, the skill match metric may be the desired candidate skill level divided by the candidate skill level, multiplied by 100%. The skill match metric (e.g., skill match metric 402) for the candidate may be outputted 106. The skill match metric for a candidate (e g , skill match metric 402) may also be displayed in a graphical user interface (e.g., GUI 400).

It should be noted that while various metrics and other information such as job/position matches discussed herein may be displayed in a GUI, other configurations are within the scope of the present disclosure. The skill match metric, and any of the other metrics, matches, and information discussed herein may be outputted through various other video and/or audio devices. For example, the metrics may be output in audio form through a phone, cell phone, and/or smart phone device. The metrics may also be output in audio form as voicemail, or as sound from a client electronic device or server computer.

While the skill match metric may be determined (e.g., calculated) and shown as a percentage (e.g., skill match metric 402 as shown in GUI 400 in FIG. 6), other variations are possible. For example, the skill match metric may be calculated and presented as a decimal. While the scale is discussed here as 1-10, if other scales are used, as discussed above (for example, the scale may be 1-100, A-F, or good-average-bad), other methods may be used to determine (e.g. calculate) the skill match metric.

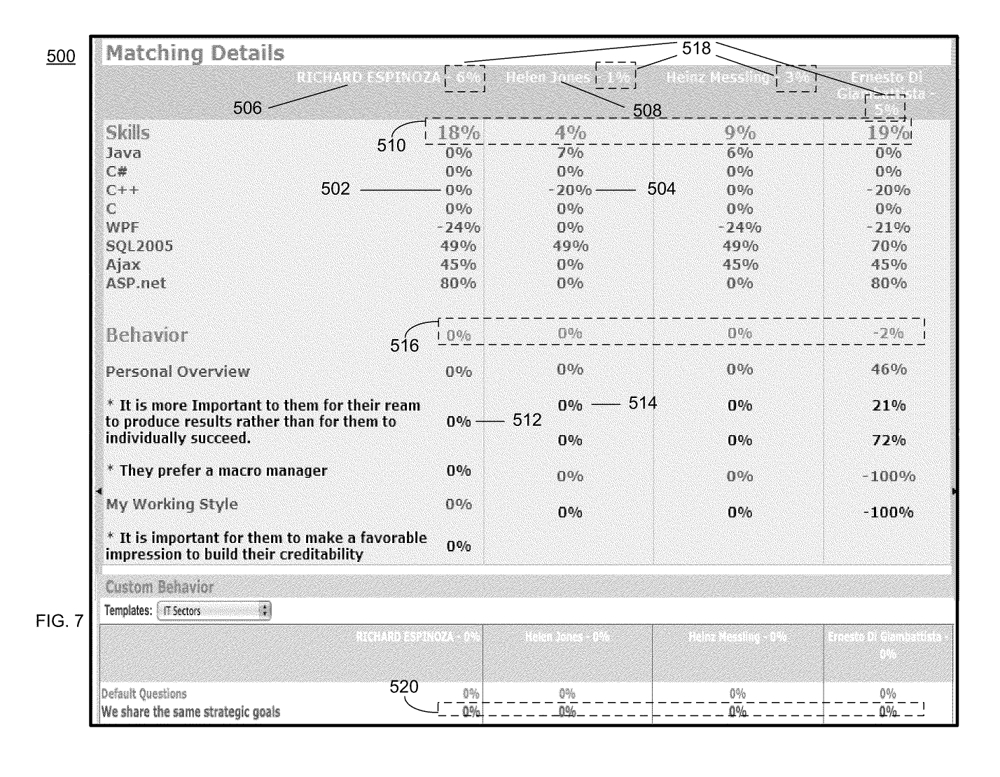

Referring now to FIG. 7, server-side CPM process 10 may display 108 a plurality of skill match metrics (e.g., skill match metrics 502 and 504) for at least two candidates (e.g., candidates 506 and 508) for a position, as shown in GUI 500. As described above, server-side CPM process 10 may determine 104 skill match metric 402 for a candidate. Server-side CPM process 10 may also determine a plurality of skill match metrics (e.g., skill match metrics 502 and 504) for at least two candidates (e.g., candidates 506 and 508) and display them in GUI 500. GUI 500 may be used by employers to compare candidates in a side-by-side fashion in order to evaluate which candidate may best fill the position.

Referring back to FIGS. 2 & 6, server-side CPM process 10 may determine 110 a candidate match metric (e.g., candidate match metric 404) for a position based upon, at least in part, a plurality of skill match metrics (e.g., plurality of skill match metrics 406) for a plurality of desired skills (e.g., plurality of desired 408). Server-side CPM process 10 may determine 110 a candidate match metric (e.g., candidate match metric 404) using a variety of methods and formulas. Again, it should be noted that the numbers shown in the figures are shown for exemplary purposes only, and may not be actual numbers calculated using the numbers shown in the figures. By way of example and not limitation, if plurality of skill match metrics 406 are 60%, 50%, 100%, and 80%, server-side CPM process 10 may determine (e.g., calculate) candidate match metric 404 as the average of the skill match metrics. The average of the skill match metrics may be calculated by adding the skill match metrics (i.e., 60%+50%+100%+80%=290%) and dividing this sum by the number of skill match metrics (i.e., 290%/4=72.5%, or 72% if rounded down). In this way, server-side CPM process 10 may determine (e.g., calculate) candidate match metric 404 to be 72%, and may also display 112 candidate metric match 404 as shown in GUI 400 in FIG. 6.

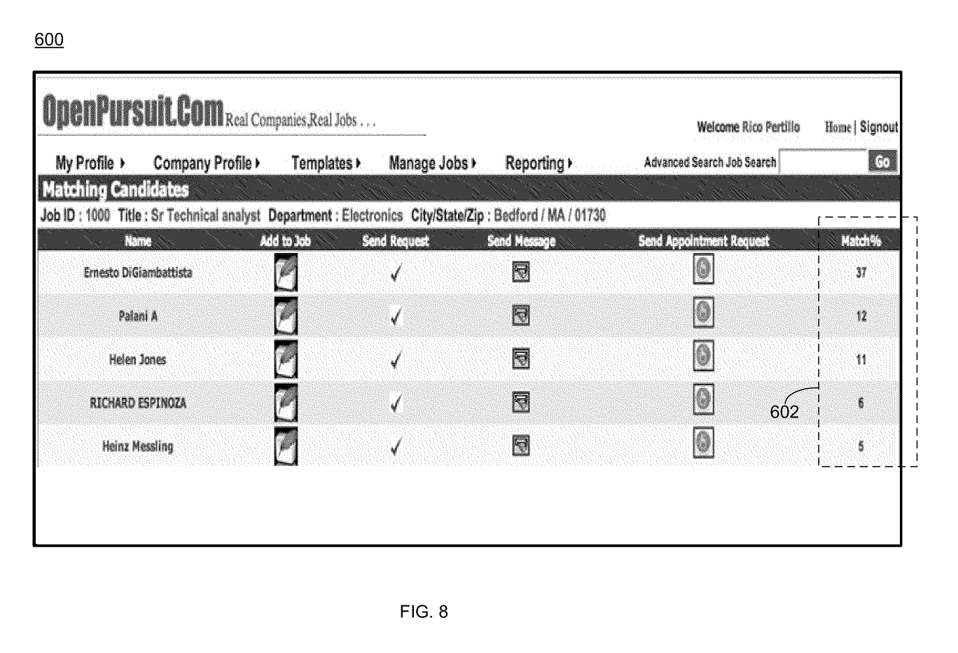

Referring to FIGS. 2, 7, & 8, server-side CPM process 10 may display 114 a plurality of candidate match metrics (e.g., plurality of candidate match metrics 510 and/or plurality of candidate match metrics 602) as shown in GUI 500 in FIG. 7, and GUI 600 in FIG. 8, respectively. As described above, server-side CPM process 10 may determine 110 candidate match metric 404 for a candidate. Server-side CPM process 10 may also determine a plurality of candidate match metrics (e.g., plurality of candidate match metrics 510 and/or plurality of candidate match metrics 602) and display them in GUI 500 and/or GUI 600. GUI's 500 and/or 600 may be used by employers to compare candidates in a side-by-side fashion in order to evaluate which candidate may best fill the position.

While the candidate match metric may be determined (e.g., calculated) and shown as a percentage (e.g., plurality of candidate match metrics 510 and/or plurality of candidate match metrics 602), other variations are possible. For example, the candidate match metric may be calculated and presented as a decimal. While the scale is discussed here as 1-10, if other scales are used, as discussed above (for example, the scale may be 1-100, A-F, or good-average-bad), other methods may be used to determine (e.g. calculate) the candidate match metric.

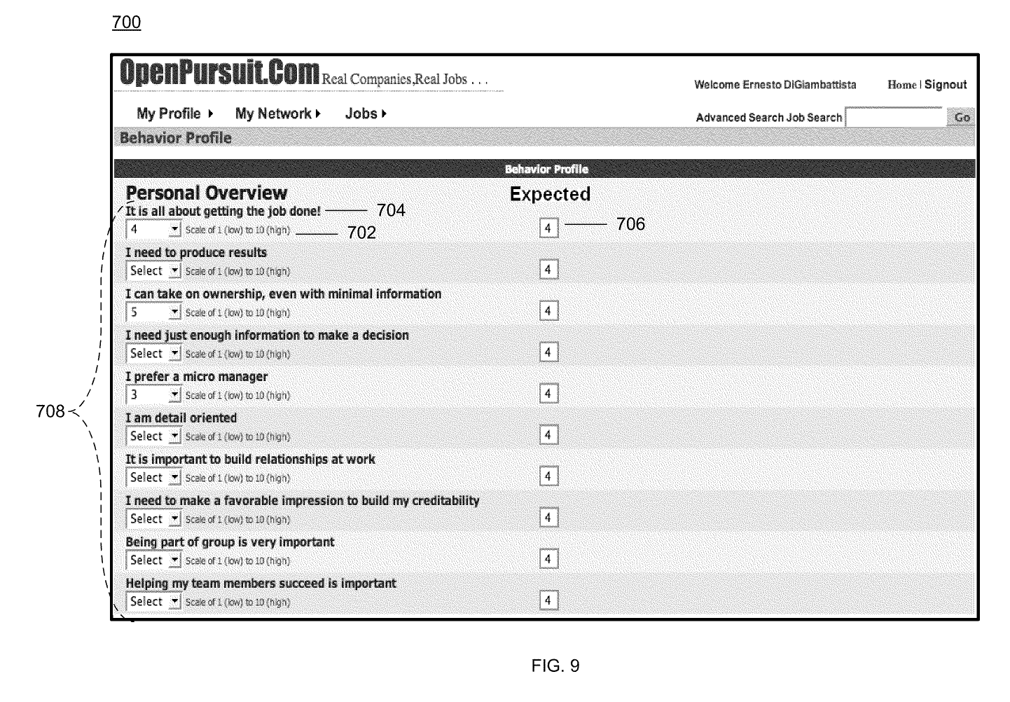

In some embodiments, additional metrics may be used to determine candidate match metrics. For example, and referring now to FIGS. 1, 2, & 9, server-side CPM process 10 may define 116 for a candidate, behavioral characteristic level 702 for predefined behavioral characteristic 704. Predefined behavioral characteristic 704 may be defined by an employer seeking to fill a position. For example, predefined behavioral characteristic 704 may be entered and/or selected, similar to predefined skills as shown in graphical user interface GUI 300 in FIG. 5, by an employer (e.g., users 44, 46, 48, or 50) at a client electronic device, including but not limited to client electronic devices 28, 30, 32, 34. Predefined behavioral characteristic 704 may also be entered by an employer at a server computer (e.g., server computer 20). Server-side CPM process 10 may receive predefined behavioral characteristic 704 (e.g., from client-side CPM process 12) and may display predefined behavioral characteristic 704 such that it appears on GUI 700, as shown in FIG. 9.

While the behavioral characteristics shown in GUI 700 may be indicative of characteristics desired in a group environment, or a hierarchical employee environment, any behavioral characteristics may be included depending on the position available. For example, if the position is a waitress position, patience, pleasantness, manners, and temperament may be behavioral characteristics included. Further, by way of example, if the position is a firefighting position, courage, determination, desire to save others, and selflessness may be behavioral characteristics included. In another example, if the position is a counseling position, compassion, understanding, and fairness may be behavioral characteristics included. Any number of behavioral characteristics may be included, and they may be broad or narrow, depending on the position and its requirements.

Behavioral characteristic level 702 may be entered by a candidate (e.g., users 44, 46, 48, or 50) seeking a position. The candidate may enter behavioral characteristic level 702 based upon importance the candidate feels regarding the behavioral characteristic, or how well the candidate feels the behavioral characteristic describes the candidate. For example, if the behavioral characteristic is “it is all about getting the job done!”, as designated by behavioral characteristic 704 in GUI 700, the candidate may enter “4”, as designated by behavioral characteristic level 702. GUI 700 may allow the candidate to choose behavioral characteristic level 702 on a 1-10 scale, however other configurations are possible. For example, the scale may be 1-100, A-F, or good-average-bad. Server-side CPM process 10 may receive behavioral characteristic level 702 (e.g., from client-side CPM process 12).

Referring back to FIG. 6, server-side CPM process 10 may determine 118 a behavioral characteristic match metric (e.g., behavioral characteristic match metric 410) for the candidate, based upon, at least in part, a behavioral characteristic level (e.g., behavioral characteristic level 702), and a desired behavioral characteristic level (e.g., desired behavioral characteristic level 706). Server-side CPM process 10 may determine 118 behavioral characteristic match metric 410 using a variety of methods and formulas. Again, it should be noted that the numbers shown in the figures are shown for exemplary purposes only, and may not be actual numbers calculated using the numbers shown. By way of example and not limitation, if the desired behavioral characteristic level is “4” (e.g., desired behavioral characteristic level 706), and the behavioral characteristic level is “4” (e.g., behavioral characteristic level 706), the behavioral characteristic match metric may be 100%. The behavioral characteristic match metric may be shown in GUI 400 as shown in FIG. 6 (e.g., behavioral characteristic match metric 410) and/or in GUI 500 as shown in FIG. 7 (e.g., behavioral characteristic match metric 512). In other words, the skill match metric may be the behavioral characteristic level divided by the behavioral characteristic level, multiplied by 100%. The behavioral characteristic match metric for a candidate (e.g., behavioral characteristic match metric 410) may be displayed 120 in a GUI (e.g., GUI 400).

While the behavioral characteristic match metric may be determined (e.g., calculated) and shown as a percentage (e.g., behavioral characteristic match metric 410 as shown in GUI 400 in FIG. 6), other variations are possible. For example, the behavioral characteristic match metric may be calculated and presented as a decimal. While the scale is discussed here as 1-10, if other scales are used (for example, the scale may be 1-100, A-F, or good-average-bad), other methods may be used to determine (e.g. calculate) the behavioral characteristic match metric.

Referring now to FIGS. 2 & 7, server-side CPM process 10 may display 122 a plurality of behavioral characteristic match metrics (e.g., behavioral characteristic match metrics 512 and 514) for at least two candidates (e.g., candidates 506 and 508) for a position, as shown in GUI 500. As described above, server-side CPM process 10 may determine 118 behavioral characteristic match metric 410 for a candidate. Server-side CPM process 10 may also determine a plurality of behavioral characteristic match metrics (e.g., behavioral characteristic match metrics 512 and 514) for at least two candidates (e.g., candidates 506 and 508) and display them in GUI 500. GUI 500 may be used by employers to compare candidates in a side-by-side fashion in order to evaluate which candidate may best fill the position.

Referring back to FIGS. 2 & 6, server-side CPM process 10 may determine 124 the candidate match metric (e.g., candidate match metric 412) for a position based upon, at least in part, a plurality of behavioral characteristic match metrics (e.g., plurality of behavioral characteristic match metrics 414) for a plurality of desired behavioral characteristics (e.g., plurality of desired behavioral characteristics 416). Server-side CPM process 10 may determine 124 the candidate match metric (e.g., candidate match metric 404) using a variety of methods and formulas. It should be noted that the numbers shown in the figures are shown for exemplary purposes only, and may not be actual numbers calculated using the numbers shown in the figures. By way of example and not limitation, if plurality of behavioral characteristic match metrics 414 are 48%, −24%, 45%, −50%, and 0%, server-side CPM process 10 may determine (e.g., calculate) candidate match metric 412 as the average of the behavioral characteristic match metrics. The average of the behavioral characteristic match metrics may be calculated by adding the skill match metrics (i.e., 48%+(−)24%+45%+(−)50%+0%=19%) and dividing this sum by the number of behavioral characteristic match metrics (i.e., 19%/5=3.8%, or 3% if rounded down). In this way, server-side CPM process 10 may determine (e.g., calculate) candidate match metric 412 to be 3%, and may also display 112 candidate metric match 412 as shown in GUI 400 in FIG. 6.

Referring to FIGS. 2 & 8, server-side CPM process 10 may display 114 a plurality of candidate match metrics (e.g., plurality of candidate match metrics 516) as shown in GUI 500 in FIG. 7. As described above, server-side CPM process 10 may determine 124 candidate match metric 412 for a candidate. Server-side CPM process 10 may also determine a plurality of candidate match metrics (e.g., plurality of candidate match metrics 512) and display them in GUI 500. GUI 500 may be used by employers to compare candidates in a side-by-side fashion in order to evaluate which candidate may best fill the position.

While the candidate match metric may be determined (e.g., calculated) and shown as a percentage (e.g., plurality of candidate match metrics 516), other variations are possible. For example, the candidate match metric may be calculated and presented as a decimal. While the scale is discussed here as 1-10, if other scales are used, as discussed above (for example, the scale may be 1-100, A-F, or good-average-bad), other methods may be used to determine (e.g. calculate) the candidate match metric.

Further, the candidate match metrics may be based upon, at least in part, either the behavioral characteristic match metrics (e.g., behavioral characteristic match metrics 512 and 514), the skill match metrics (e.g., skill match metrics 502 and 504), or both the behavioral characteristic match metrics and the skill match metrics. For example, candidate match metrics 518 may be determined as an average or weighted average, as desired by the employer, of candidate match metrics 510, which are based on skill match metrics, and candidate match metrics 516, which are based on behavioral characteristic match metrics. Candidate match metrics 518 may be displayed on GUI 500, as shown in FIG. 7. While candidate match metrics 518 may be determined (e.g., calculated) and shown as a percentage, other variations are possible. For example candidate match metric 518 may be calculated and presented as decimals. While the scale is discussed here as 1-10, if other scales are used, as discussed above (for example, the scale may be 1-100, A-F, or good-average-bad), other methods may be used to determine (e.g. calculate) candidate match metrics 518.

Referring back to FIGS. 2, 4, & 5, in some embodiments, server server-side CPM process 10 may create 126 template 306 for a position including plurality of predefined skills 308, each predefined skill having a definable candidate skill level (e.g., candidate skill level 202). Employers may use template 306 to choose various skills (e.g., C#, C++, SAP, SQL2005) needed for a position, such as “Senior SAP Architect”, as shown in GUI 300 in FIG. 5. Employers may choose desired candidate skill level 304 for each of the plurality of predefined skills 308. With the employer's selection, server-side CPM process 10 may define 128 desired candidate skill level 304 for each of the plurality of predefined skills 308. Further, employers may choose the weight (e.g., weight 310) to be allocated to each skill (e.g., C#, C++, SAP, SQL2005). These weights may be used to determine (e.g., calculate) the various metrics described herein with, for example, a weighted average formula. As shown in GUI 300, template 306 may also allow the employer to select whether or not the skill is required by selecting a checkbox (e.g., checkbox 312). Employers may then name (e.g., “Senior SAP Architect”), save, and reuse template 306 at a later time so they do not have to create it over again. Alternatively, employers may open template 306 at a later time and make changes to it if different skills, skill levels, etc., become required for the position. They may also make changes to template 306 and use it later for a different position.

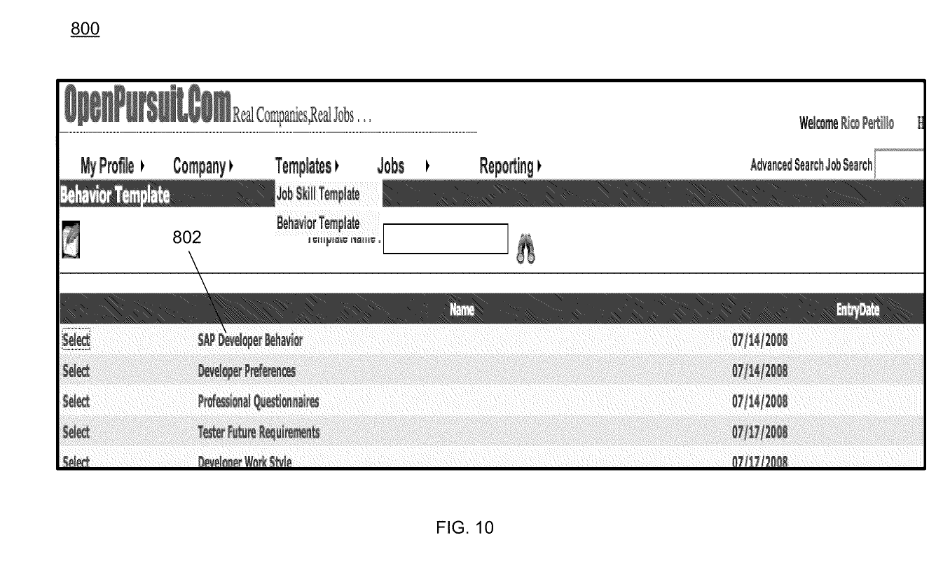

Similarly, and referring also to FIGS. 9 & 10, server server-side CPM process 10 may include 130 in the template (e.g., template 306) a plurality of predefined behavioral characteristics (e.g., plurality of predefined behavioral characteristics 708), each behavioral characteristic having a definable behavioral characteristic level (e.g., behavioral characteristic level 702). Employers may use the template (e.g., template 306) to choose various behavioral characteristics (e.g., “It is all about getting the job done!”, or “I need to produce results”) needed for a position, such as “SAP Developer”, as shown in GUI 800 in FIG. 10. Employers may choose desired behavioral characteristic level 706 for each of plurality of predefined behavioral characteristics 708. With the employer's selection, server server-side CPM process 10 may define 132 desired behavioral characteristic level 706 for each of the plurality of predefined behavioral characteristics 708. Further, employers may choose a weight to be allocated to each behavioral characteristic (e.g., “It is all about getting the job done!”, or “I need to produce results”). These weights may be used to determine (e.g., calculate) the various metrics described herein with, for example, a weighted average formula. The template may also allow the employer to select whether or not the behavioral characteristic is required by selecting a checkbox. Employers may then name (e.g., “SAP Developer Behavior”, “Developer Preferences” as shown in GUI 800), save, and reuse the template at a later time so they do not have to create it over again. Alternatively, employers may open the template at a later time and make changes to it if different behavioral characteristics, desired behavioral characteristic levels, etc., become required for the position. They may also make changes to the template and use it later for a different position.

In one embodiment, the candidate match metric for a candidate (e.g., candidate match metrics 518 as shown in GUI 500 in FIG. 7) may be determined based upon, at least in part, a professional history of the candidate, an educational history of the candidate, or both. Server-side CPM process 10 may obtain the professional history and/or educational history of a candidate in a variety of ways. For example, the candidate (e.g., users 44, 46, 48, 50) may provide a professional history and/or an educational history to server-side CPM process 10 in the form of a resume or cover letter.

### The Collaborative Career Development Application

As discussed above, the server-side CPM process 10 and/or client-side CPM process 12 may be part of a collaborative career development application (CCDA) which may run on a server computer (e.g. server computer 20), a client electronic device (e.g., client electronic devices 28, 30, 32, 34), or may be a hybrid server-side/client-side application. All of the operations carried out by the CCDA may be carried out by either server-side CPM process 10, client-side CPM 12, or one or more other processes which may be a part of the CCDA. The CCDA may allow the user to upload or post various types of candidate application documents such as resumes, cover letters, letters of recommendation, transcripts, and the like.

The CCDA may be a Software as a Service (SaaS) deployment. In other words, a provider (for example, Open Pursuit, Inc.) may license the CCDA to customers (e.g., employers) as a service on demand. The provider may host the CCDA on its own web servers (e.g., server computer 20) or download the CCDA to the customer device (e.g., client electronic devices 28, 30, 32, 34). Further, the CCDA may use various data mining techniques and search engines to perform the functions and operations described herein.

The CCDA may also interface and/or communicate with various social networks via server-side CPM process 10, client-side CPM 12, or another process, in order to exchange information such as professional and educational history information (e.g., resumes, cover letters, letters of recommendation, transcripts). For example, the CCDA may interface and/or communicate with social networks such as Facebook™ or Linkedin™ to obtain professional and educational history information. The CCDA may further obtain candidate skill level and behavioral characteristic level information about candidates, such as those described above, from social networks. The CCDA may also obtain position information from various social networks, such as employers with open positions, and requirements of those open positions.

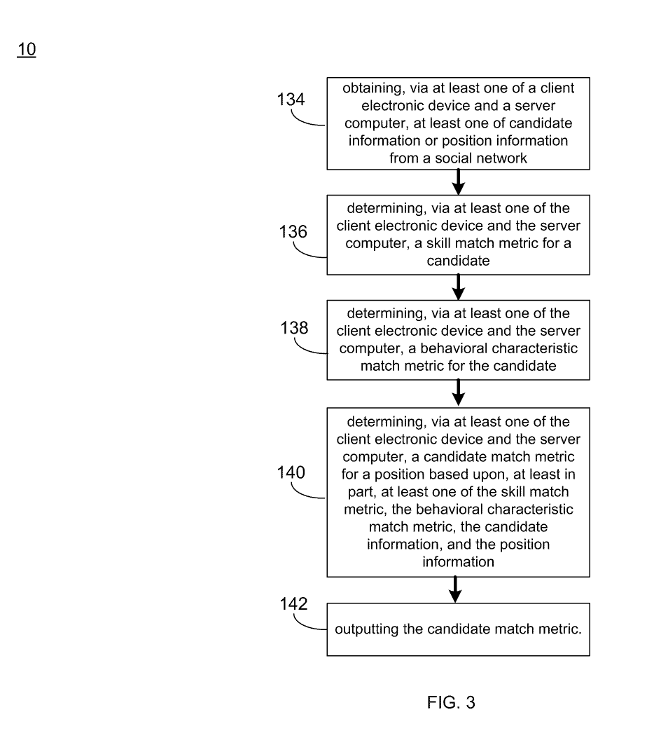

Referring now to FIG. 3, in one implementation, server-side CPM process 10 may obtain 134 at least one of candidate information or position information from a social network, as described above. Further, server-side CPM process 10 may determine 136 a skill match metric for the candidate. Server-side CPM process 10 may determine the skill match metric as described above, but may additionally use the candidate information or position information obtained through the social network to determine the skill match metric for the candidate. Server-side CPM process 10 may obtain any of the information described herein regarding candidate skills and behavioral characteristics from social networks, in addition to professional and educational history information, and may use any of this information to determine the skill match metric. Server-side CPM process 10 may determine 138 a behavioral characteristic match metric for the candidate. Similarly, server-side CPM process 10 may determine the behavioral characteristic match metric as described above, but may additionally use the candidate information or position information obtained through the social network to determine the behavioral characteristic match metric for the candidate. Server-side CPM process 10 may obtain any of the information described herein regarding candidate skills and behavioral characteristics from social networks, in addition to professional and educational history information, and may use any of this information to determine the behavioral characteristic match metric.

Continuing with the above example, server-side CPM process 10 may determine 140 a candidate match metric for a position based upon, at least in part, at least one of the skill match metric, the behavioral characteristic match metric, the candidate information, and the position information. As explained above, the candidate information and position information may be entered by the candidate or the employer, or may be obtained from a social network. This information may be used to determine the skill match metric, the behavioral characteristic match metric, or the candidate match metric. Server-side CPM process 10 may output 142 the candidate match metric. Server-side CPM process 10 may also display the candidate match metric in a GUI, such as GUI 500.

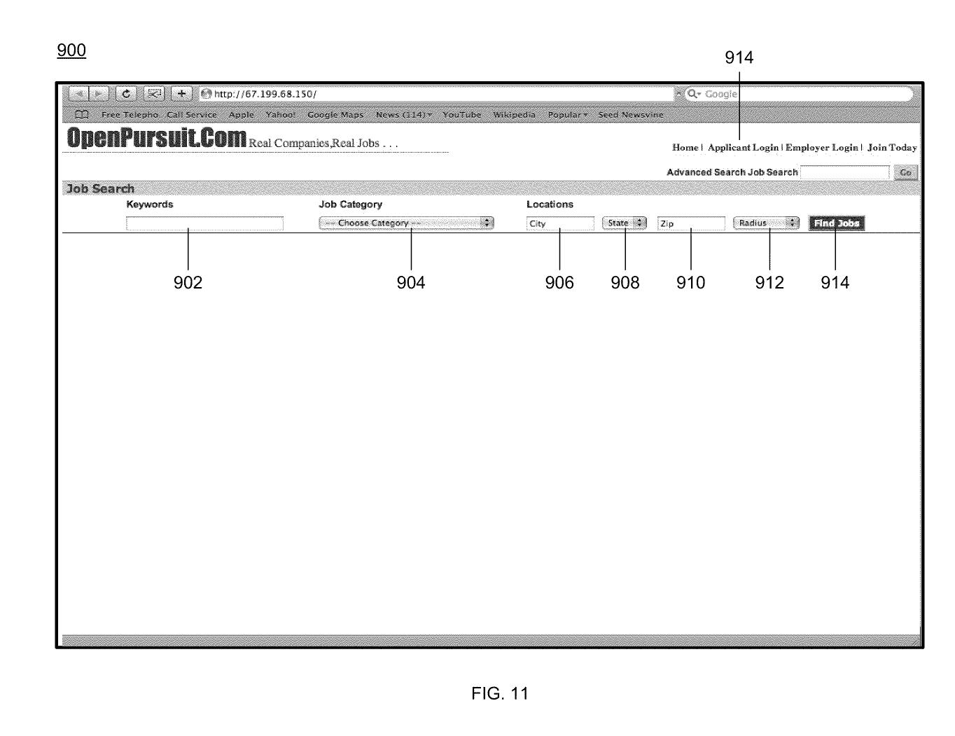

The CCDA may generate, create, and/or display a number of GUI's which may assist candidates and employers. For example, the CCDA may display GUI 900 as shown in FIG. 11. GUI 900 may be a “Main Page” where candidates are able to start when first using the CCDA or first looking for a position. GUI 900 may allow candidates to enter keywords in keyword field 902, select a job category in job category list box 904, enter a city in city field 906, choose a state in state list box 908, enter a zip code in zip code field 910, or enter a radius in radius list box 912. The CCDA may use one or more of these pieces of information entered by the candidate to search a jobs (i.e., positions) database in order to find available positions. The CCDA may execute the search after the candidate selects find jobs button 914. The text entered may be searched through employer job postings (e.g., corporate job postings) for keywords in job descriptions and skill sets. Text may be entered in a standard format used by the CCDA, and the CCDA may use a search engine to find the text entered. The CCDA may also allow a candidate to login after clicking applicant login link 916, which may allow a candidate (i.e., a user) to enter a username and password.

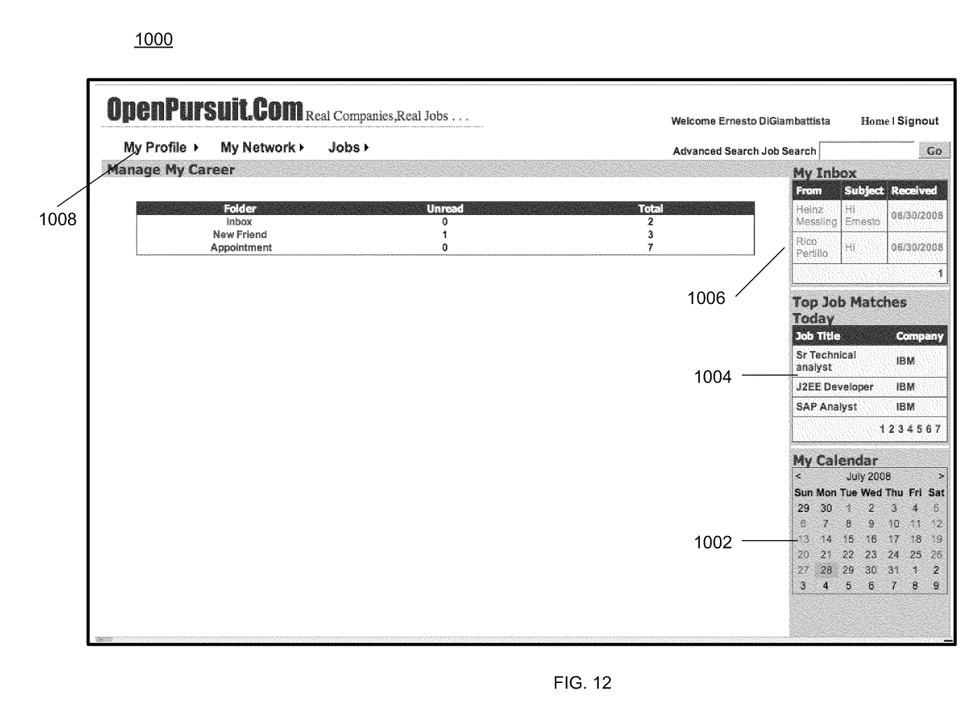

After a candidate has logged in, the CCDA may display GUI 1000 as shown in FIG. 12. GUI 1000 may be a “Member Page” or “User Dashboard” where candidates are able to manage and view their candidate information. For example, candidates may view and edit their calendar 1002 (e.g., “My Calendar”), view their job matches 1004, or view their integrated email box 1006. Selecting either calendar 1002, job matches 1004, and integrated email box 1006 may cause the CCDA to display a popup window or new GUI showing further details regarding the candidate's calendar, job matches, and/or email. The candidate may view and edit one or more of these items from the popup window or new GUI. Integrated email box 1006 may be configured to receive and show all the candidate's email from various email servers. Job matches 1004 may show job matches based on various candidate skill levels, behavioral characteristic levels, and/or metrics determined, as described above. The CCDA may compare the various candidate skill levels and behavioral characteristic levels with levels desired for positions by employers, and match candidates with positions based on this comparison. A candidate may add events to their calendar 1002 such as professional events (e.g., job fairs) or social events. Calendar 1002 may be configured to sync with the candidate's smart phone and/or cell phone. By selecting my profile link 1008, the candidate may view their “Member Profile”.

After the candidate has logged in, the CCDA may display GUI 1100. GUI 1100 may be a “Member Profile” page where candidates are able to manage and view their profile information. For example, candidates may view and edit their general information 1102, employment history 1104 (e.g., professional history), and education history 1106. Selecting employer name links (e.g., employer name link 1108) or education level links (e.g., education level link 1110) may cause the CCDA to display a popup window or new GUI showing further details regarding the candidate's previous employers and education history. The candidate may view and edit one or more of these items from the popup window or new GUI. The information entered by the candidate via GUI 1100 may be entered in CCDA standard format, which may allow the CCDA to use the information while carrying out job searches.

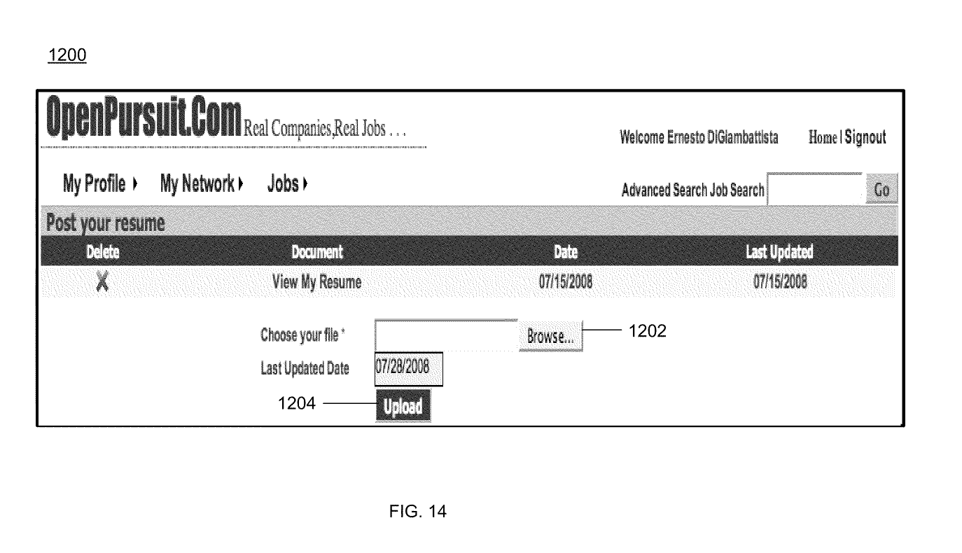

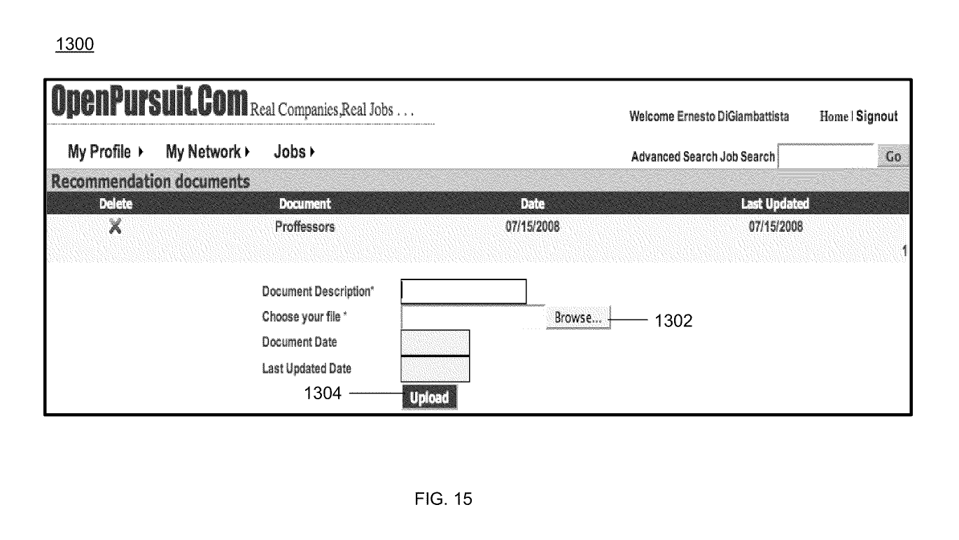

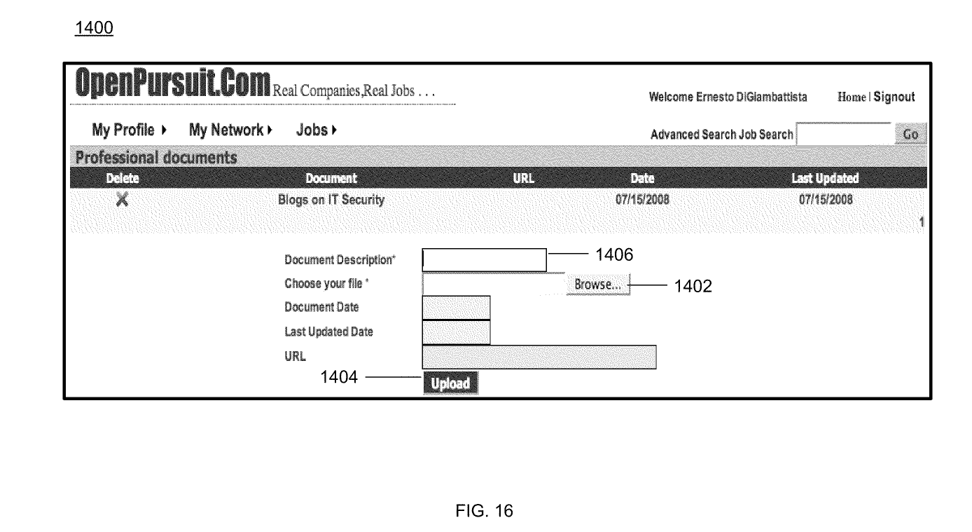

Referring now to FIGS. 14-16, the candidate may upload application documents in GUI's 1200, 1300, and 1400, respectively. For example, in GUI 1200 of FIG. 14, the candidate may upload one or more resumes or cover letters. The candidate may also select a primary resume and cover letter to be reviewed by recruiters and/or companies. The candidate may name each resume with a unique title. The candidate may browse through local files to find a resume and/or cover letter to upload by selecting browse button 1202. After selecting a resume and/or cover letter the candidate may upload it using upload button 1204. Similarly, in GUI 1300 of FIG. 15, the candidate may upload recommendation letters to be viewed by recruiters and/or companies. The candidate may name each recommendation letter with a unique title. The candidate may browse through local files to find a recommendation letter to upload by selecting browse button 1302. After selecting a recommendation letter, the candidate may upload it using upload button 1304. Further, in GUI 1400 of FIG. 16, the candidate may upload professional documents such as writing samples, professional awards, white papers, and other relevant documents. The candidate may browse through local files to find a professional document to upload by selecting browse button 1402. After selecting a professional document, the candidate may upload it using upload button 1404. They may also describe the document in document description box 1406.

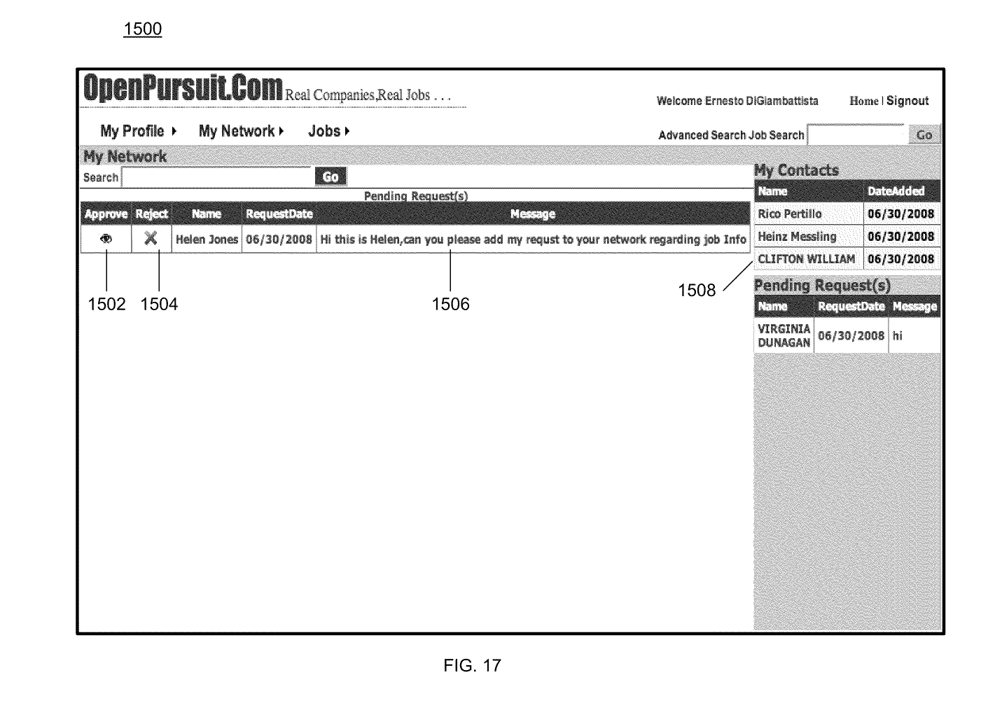

As described above, the CCDA may obtain data from social networks. Referring to FIG. 17, GUI 1500 may provide candidates with the ability to socially network with members (e.g., candidates with a user name and password). GUI 1500 may also act as a gateway to other social networks, such as Facebook™, Linkedin™, or Google™. The CCDA may allow members to login into their Facebook™, Linkedin™ or Google™ accounts and share job opportunities and/or other information. Members can also send or receive invitations from other members so they may be included in each others' contact lists. Members may approve 1502 or reject 1504 invitations (e.g., invitation 1506) so that other members may be included in contact list 1508.

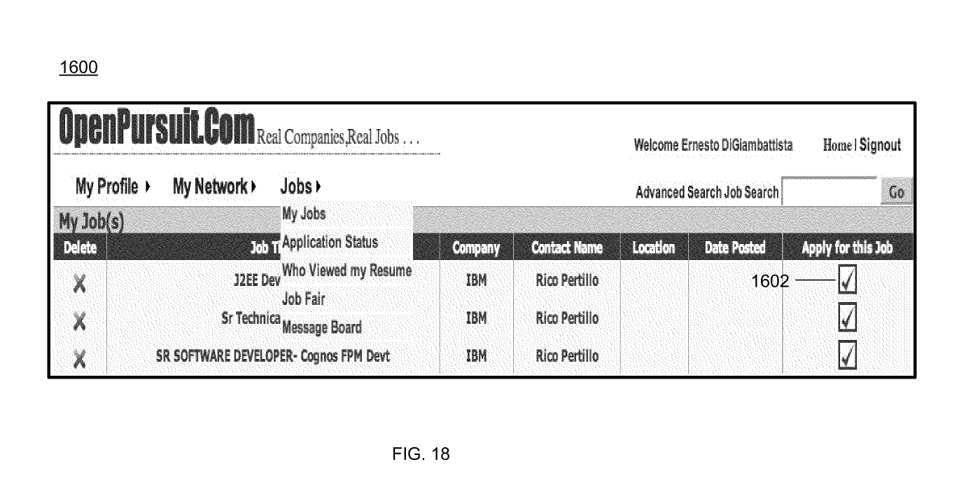

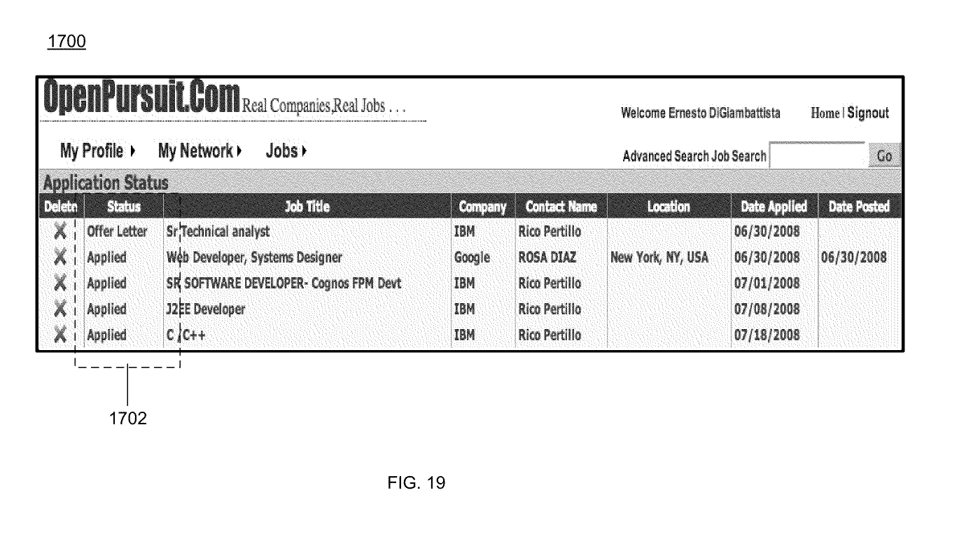

Referring now to FIG. 18, the CCDA may provide GUI 1600 allowing the candidate to view all their matching jobs. The candidate may apply to the job (e.g., by selecting “Apply for this Job” checkbox 1602″) and get confirmation of their submission. As shown in FIG. 19, the CCDA may also provide GUI 1700 allowing the candidate to view all their application statuses (e.g. application statuses 1702) on one screen. Employers/corporations may change the application status from applied to reviewed, or to first interview, or other designation describing where the applicant is in the employer's hiring process. In this way, the candidate may get an updated status based on where the candidate's application is in the employer's hiring process flow. GUI 1700 may also allow the candidate to withdraw from a job application and/or a view contact person for the position.

The CCDA may also provide GUI's that may be used by employers/corporations. For example, the CCDA may provide GUI 1800 which may be an “Employer Dashboard”. The employer dashboard may allow the employer/corporation to search (e.g., search 1802) for candidates based on names or keywords. Employers may also use an advanced search 1804 which may search based upon location, degree, and other job qualifications. The employer may have integrated email box 1806 which may allow the employer to view emails from multiple email servers and/or email applications such as Outlook™. The employer may use the integrated email feature to communicate with potential candidates, as well as other employees within the organization and/or corporation. GUI 1800 may also provide applied candidate list 1808, which may be constantly updated. GUI 1800 may further include calendar 1810 which may offer similar functionality to that of calendar 1002. Further, the employer may create a company profile detailing information about the company for potential candidates to view. The employer may also post and manage available positions/jobs from the employer dashboard. Additionally, the employer dashboard may include a professional networking component allowing the organization/corporation to stay in communication with past, present, and future applicants, as well as fellow employees.

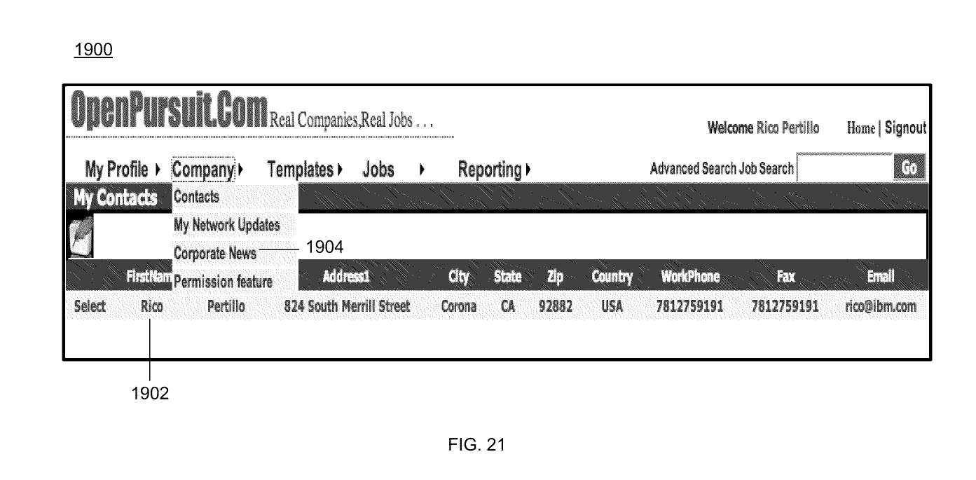

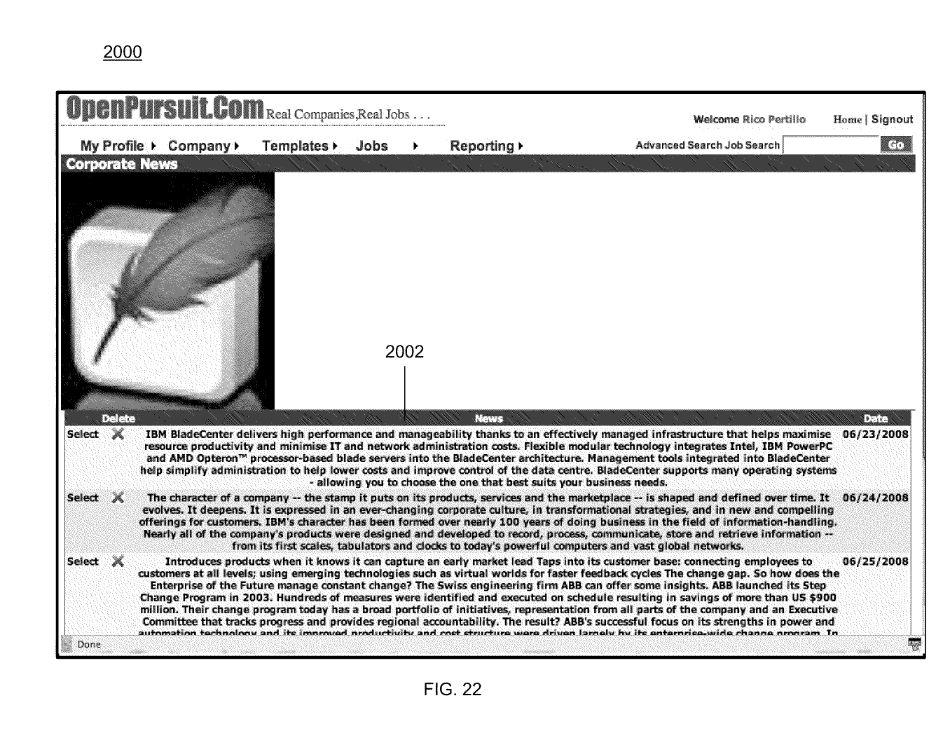

The CCDA may also provide GUI 1900, as shown in FIG. 21. GUI 1900 may be a “Company Members” page. GUI 1900 may allow employees within a company to organize their contact list (e.g., contact list 1902) of candidates/applicants and also other employees of the company. Upper level employees may control a permission feature which may determine the access of lower employees to GUI 1900 as well as other employer GUI's described herein and provided by the CCDA. By clicking on corporate news link 1904, GUI 2000, as shown in FIG. 22, may be displayed and may allow employers to update and read company news. Company news 2002 may be any news and/or updates the company would like to post. Company news 2002 may be displayed to potential candidates who want to learn more about the company.

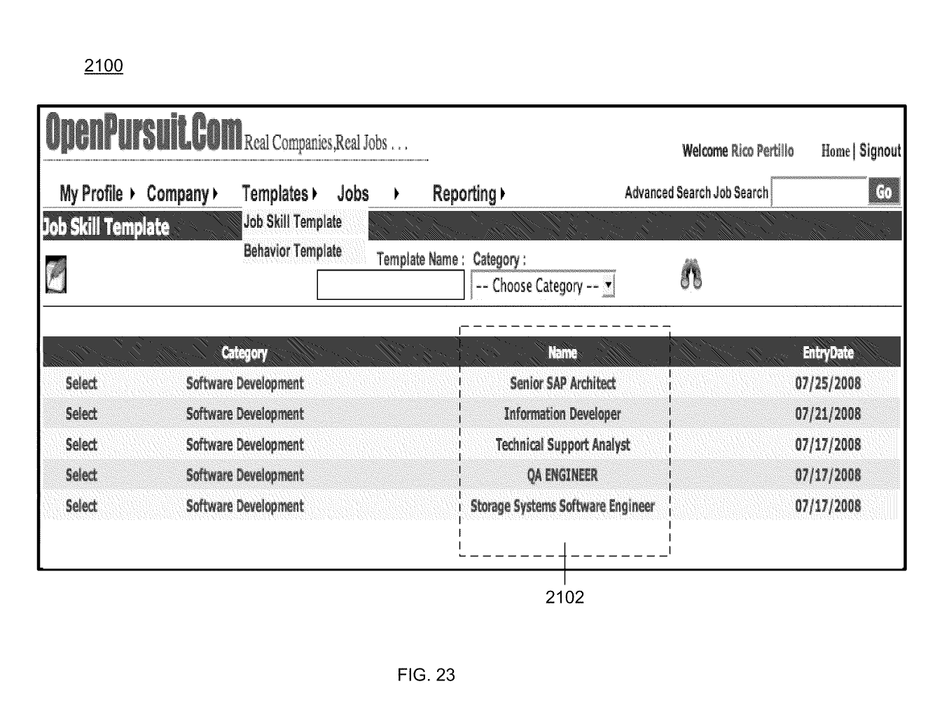

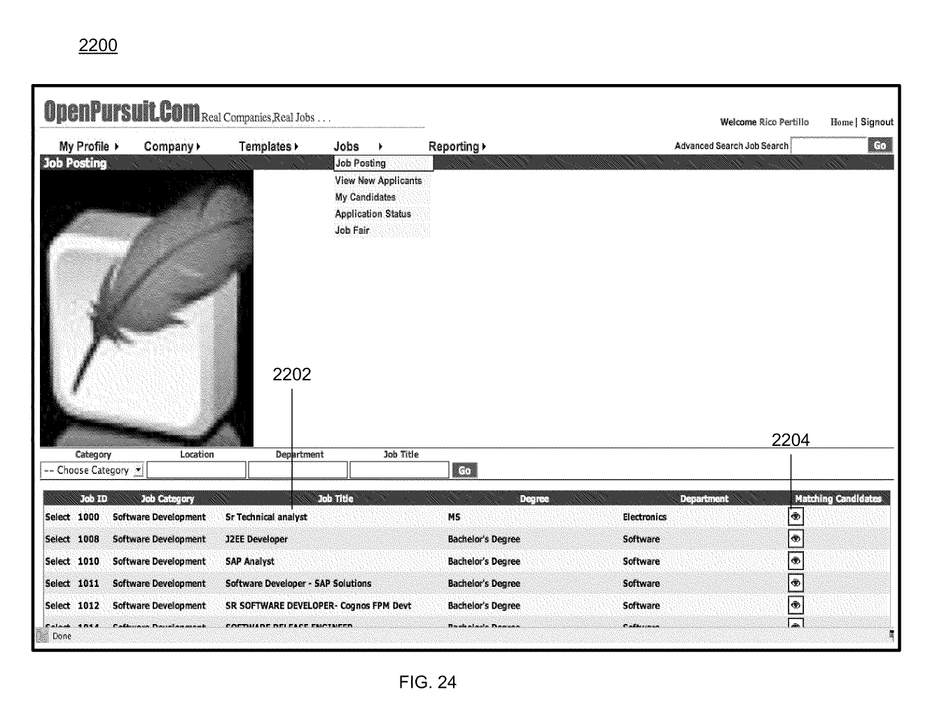

Further, employers may create position/job postings in GUI 2100 provided by the CCDA, as shown in FIG. 23. GUI 2100 may be a “Job Posting Template” and may allow employers to create jobs and save the template for future use. Job postings 2102 may include job descriptions and necessary qualifications including required and/or desired skills and behavioral characteristics. The templates described above regarding server-side CPM process 10 (e.g., template 306) may be used with GUI 2100. Referring to FIG. 24, employers may keep track of each position/job 2202, and candidates that have applied to the job, with GUI 2200 provided by the CCDA. GUI 2200 may be a “Job Posting Status” and may also allow employers to view matching candidates by selecting matching candidate button 2204, which may have been generated by the CCDA.

Referring back to FIG. 8, GUI 600 may display a number of potential candidates matched using the search engine of the CCDA, and the candidate match metric of each potential candidate. As discussed above, candidate match metrics (e.g., candidate match metrics 602) may be based upon qualifications (e.g., professional and education history), candidate skill levels, and/or behavioral characteristic levels. The candidate match metrics may then be matched to specific job postings using the search engine of the CCDA. In this way, the CCDA may compare skill match metrics, behavioral characteristic match metrics, and candidate match metrics to requirements of job postings (i.e., desired skill match metrics and behavioral characteristic match metrics) and match or suggest candidates. Once candidates are matched or suggested by the CCDA, employers may contact them (e.g., send requests) to ask them to apply to certain jobs.

It should be noted that the term “employer” as used herein may refer to any person looking to fill an available job/position. Those using the CCDA to find (i.e., match) candidates for jobs/positions (i.e., users) may be corporate human resource workers, corporate recruiters, corporate hiring managers, third party recruiters, and/or others looking to fill positions. Any of these users may search the candidate information database of the CCDA which may include any of the candidate information described herein for many candidates. Further, candidates may use the candidate information they have entered, as described herein, to search the jobs/position database in order to find jobs/positions having requirements that match their professional/educational experiences and/or their candidate skill levels and behavioral characteristic levels.

Referring back to FIG. 7, once the CCDA matches or suggests candidates, the employer may view GUI 500 to compare the matched candidates in a side by side fashion, as described above. The employer may decide that more information about the candidates is needed, and may subsequently request that the matched candidates provide more information. This information may be, for example, custom behavioral characteristics, as shown at the bottom of GUI 500 (i.e., “Custom Behavior”). Any number and type of qualitative or quantitative custom behavioral characteristics may be requested, and the suggested candidates may provide custom behavioral characteristic levels for use in determining custom behavioral characteristic metrics (e.g., custom behavioral characteristic metrics 520), similar to determining behavioral characteristic metrics as described above. Qualitative custom behavioral characteristics may be, for example, whether someone prefers to go out on a Saturday evening, or stay in, or whether a candidate prefers to work four 10-hour days, or five 8-hour days per week (each may be indicated on a scale, e.g., 1-10, 1-100, A-F, good-average-bad. etc., by the candidate). Quantitative custom behavioral characteristics may be, for example, how many words a candidate can type per minute, or how many computer programs a candidate has designed in their career. Quantitative custom behavioral characteristics may be answered with text or numbers (i.e., 50 words per minute) rather than on a scale or rating basis.

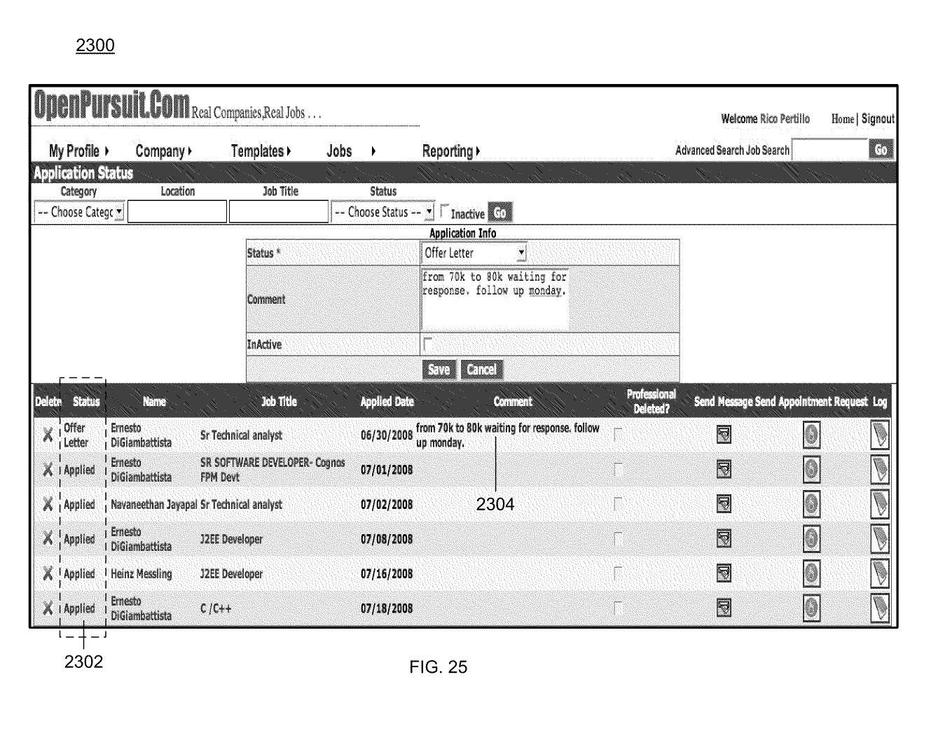

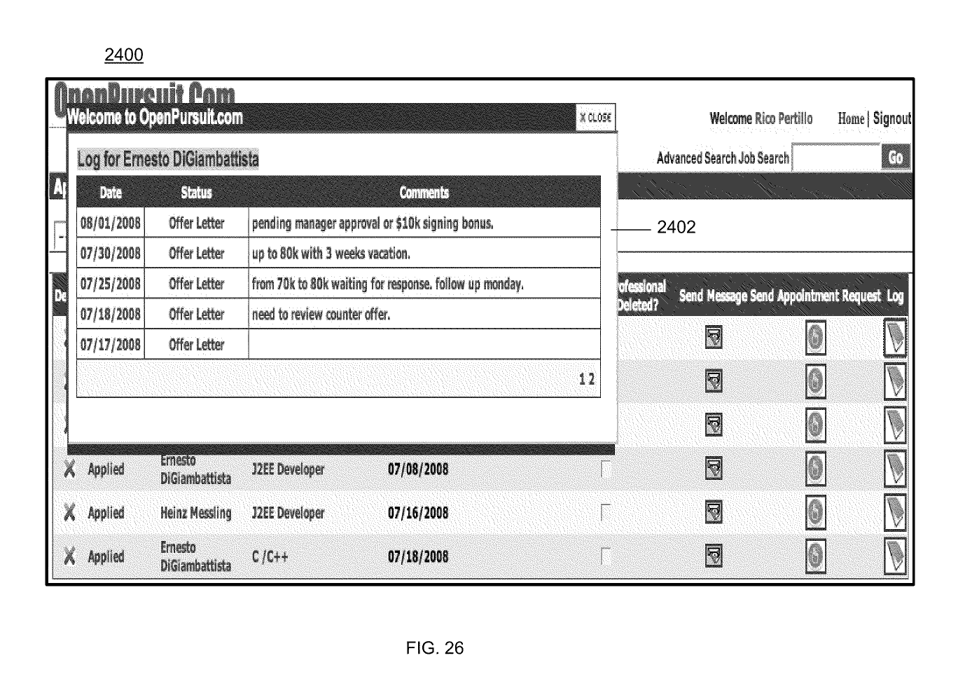

The CCDA may further provide GUI 2300 as shown in FIG. 25. GUI 2300 may allow employers to view and/or change candidate statuses 2302. These candidate statuses (i.e., application statuses) may then be viewed by candidates, as described above. Employers may also make comments/notes 2304 about each candidate in GUI 2300. GUI 2300 may also provide an internal communication flow which may allow companies to communicate internally regarding candidate statuses. Since candidates may often interview with more than one person at a company, employers may need to be on the same page regarding candidate statuses. Here employers may view each others' notes for a candidate that more than one person in the company may have interviewed. Often times, more than one person at a company may make notes regarding information they have learned about the candidate through interviews and other communications. The CCDA may provide GUI 2400, as shown in FIG. 26, so that employers may view all the comments/notes (e.g. comments/notes 2402) taken regarding a candidate by people at the company involved in the hiring process.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

What is claimed is:

1. A method comprising:
defining for a candidate, via at least one of a client electronic device and a server computer, a candidate skill level for a predefined skill;
determining, via at least one of the client electronic device and the server computer, a skill match metric for the candidate, based upon, at least in part, the candidate skill level and a desired candidate skill level; and
outputting the skill match metric for the candidate.

2. The method of claim 1 further comprising:
determining a candidate match metric for a position based upon, at least in part, a plurality of skill match metrics for a plurality of desired skills; and
displaying at least one of the skill match metric and the candidate match metric in a graphical user interface.

3. The method of claim 2 further comprising:
displaying a plurality of candidate match metrics for the position.

4. The method of claim 1 further comprising:
displaying a plurality of skill match metrics for at least two candidates for the position.

5. The method of claim 2 wherein determining the candidate match metric further comprises:
defining for the candidate, via at least one of the client electronic device and the server computer, a behavioral characteristic level for a predefined behavioral characteristic;
determining, via at least one of the client electronic device and the server computer, a behavioral characteristic match metric for the candidate based upon, at least in part, the behavioral characteristic level and a desired behavioral characteristic level; and
displaying the behavioral characteristic match metric for the candidate.

6. The method of claim 3 further comprising:
determining the candidate match metric for the position based upon, at least in part, a plurality of behavioral characteristic match metrics for a plurality of desired behavioral characteristics; and
displaying the candidate match metric.

7. The method of claim 6 further comprising:
displaying a plurality of behavioral characteristic match metrics for at least two candidates for the position.

8. The method of claim 1 further comprising:
creating a template for the position including a plurality of predefined skills, each predefined skill having a definable candidate skill level; and
defining in the template the desired candidate skill level for each predefined skill

9. The method of claim 8 further comprising:
including in the template a plurality of predefined behavioral characteristics, each behavioral characteristic having a definable behavioral characteristic level; and
defining in the template the desired behavioral characteristic level for each predefined behavioral characteristic.

10. The method of claim 6 wherein determining the candidate match metric is further based upon, at least in part, at least one of a professional history and an educational history.

11. The method of claim 7 wherein at least one of the skill match metric, the candidate match metric, and the behavioral characteristic match metric is a percentage.

12. A computer program product residing on a computer readable storage medium having a plurality of instructions stored thereon, which, when executed by a processor, cause the processor to perform operations comprising:
defining for a candidate, via at least one of a client electronic device and a server computer, a candidate skill level for a predefined skill;
determining, via at least one of the client electronic device and the server computer, a skill match metric for the candidate, based upon, at least in part, the candidate skill level and a desired candidate skill level; and
outputting the skill match metric for the candidate.

13. The computer program product of claim 12 further comprising instructions for:
determining a candidate match metric for a position based upon, at least in part, a plurality of skill match metrics for a plurality of desired skills; and
displaying at least one of the skill match metric and the candidate match metric in a graphical user interface.

14. The computer program product of claim 14 further comprising instructions for:
displaying a plurality of candidate match metrics for the position.

15. The computer program product of claim 12 further comprising instructions for:
displaying a plurality of skill match metrics for at least two candidates for the position.

16. The computer program product of claim 13 further comprising instructions for:
defining for the candidate, via at least one of the client electronic device and the server computer, a behavioral characteristic level for a predefined behavioral characteristic;
determining, via at least one of the client electronic device and the server computer, a behavioral characteristic match metric for the candidate based upon, at least in part, the behavioral characteristic level and a desired behavioral characteristic level; and
displaying the behavioral characteristic match metric for the candidate.

17. The computer program product of claim 13 further comprising instructions for:
determining the candidate match metric for the position based upon, at least in part, a plurality of behavioral characteristic match metrics for a plurality of desired behavioral characteristics; and
displaying the candidate match metric.

18. The computer program product of claim 17 further comprising instructions for:
displaying a plurality of behavioral characteristic match metrics for at least two candidates for the position.

19. The computer program product of claim 12 further comprising instructions for:
creating a template for the position including a plurality of predefined skills, each predefined skill having a definable candidate skill level; and
defining in the template the desired candidate skill level for each predefined skill

20. The computer program product of claim 19 further comprising instructions for:
including in the template a plurality of predefined behavioral characteristics, each behavioral characteristic having a definable behavioral characteristic level; and
defining in the template the desired behavioral characteristic level for each predefined behavioral characteristic.

21. The computer program product of claim 17 wherein determining the candidate match metric is further based upon, at least in part, at least one of a professional history and an educational history.

22. The computer program product of claim 17 wherein at least one of the skill match metric, the candidate match metric, and the behavioral characteristic match metric is a percentage.

23. A method comprising:
obtaining, via at least one of a client electronic device and a server computer, at least one of candidate information or position information from a social network;
determining, via at least one of the client electronic device and the server computer, a skill match metric for a candidate;
determining, via at least one of the client electronic device and the server computer, a behavioral characteristic match metric for the candidate;
determining, via at least one of the client electronic device and the server computer, a candidate match metric for a position based upon, at least in part, at least one of the skill match metric, the behavioral characteristic match metric, the candidate information, and the position information; and
outputting the candidate match metric.
